(19) United States
(12) Patent Application Publication
(10) Pub. No.: US 2021/0077955 A1
(43) Pub. Date: Mar. 18, 2021

(54) SYSTEM AND METHOD OF DESALINATION OF WATER

(71) Applicant: ISRAEL AEROSPACE INDUSTRIES LTD., Lod (IL)

(72) Inventor: Benaya Hoz, Kiryat Ono (IL)

(21) Appl. No.: 17/108,267

(22) Filed: Dec. 1, 2020

Related U.S. Application Data
(63) Continuation of application No. 14/145,068, filed on Dec. 31, 2013, now abandoned.
Application No. 14/145,068 is a division of application No. 13/603,028, filed on Sep. 4, 2012, now abandoned.

(51) Int. Cl. B01D 65/02; C02F 1/44; B01D 61/02; B01D 65/08; B01D 61/08; B01D 61/12

(52) U.S. Cl. CPC B01D 65/02; C02F 1/441; B01D 61/025; C02F 2103/08; B01D 61/08; B01D 61/12; B01D 65/08

(57) ABSTRACT

A water desalination system including at least one reverse osmosis desalination unit, including at least one reverse osmosis membrane and having a saline water inlet at a feed side of the at least one reverse osmosis membrane and a permeate outlet at a permeate side of the at least one reverse osmosis membrane, and an intermittent cleaning control subsystem operative to provide intermittent cleaning of the at least one reverse osmosis membrane by at least one of narrowing or closing the permeate outlet, thereby causing an increase of pressure of the permeate at the permeate side of the at least one reverse osmosis and reducing the feed pressure, without significantly increasing the permeate pressure, thereby causing permeate to flow from the permeate side to the feed side of a membrane and flushing foulants to a location outside of the desalination unit.

### FIELD OF THE INVENTION

The present invention relates to desalination generally.

### BACKGROUND OF THE INVENTION

The following patent publications are believed to represent the current state of the art: U.S. Pat. Nos. 3,853,756 and 7,563,375.

### SUMMARY OF THE INVENTION

The present invention seeks to provide improved methods and systems for desalination of water. There is thus provided in accordance with a preferred embodiment of the present invention a system for desalination of water, the system including at least one reverse osmosis desalination unit including at least one reverse osmosis membrane and having a saline water inlet at a feed side of the at least one reverse osmosis membrane and a permeate outlet at a permeate side of the at least one reverse osmosis membrane, the at least one reverse osmosis desalination unit receiving saline water containing foulants via the saline water inlet at a feed pressure which exceeds the osmotic pressure of the saline water, thereby causing permeate to flow through the at least one reverse osmosis membrane to the permeate side of the at least one reverse osmosis membrane and foulants to be trapped in the at least one reverse osmosis membrane and an intermittent cleaning control subsystem operative to provide intermittent cleaning of the at least one reverse osmosis membrane by causing the permeate to pass through the reverse osmosis membrane from the permeate side to the feed side, thereby dislodging foulants from the reverse osmosis membrane into the saline water at the feed side of the at least one reverse osmosis membrane, enabling the foulants to be flushed from the feed side to a location outside of the at least one reverse osmosis desalination unit by at least one of: narrowing the permeate outlet, thereby causing an increase in the pressure of the permeate at the permeate side of the at least one reverse osmosis membrane, closing the permeate outlet, thereby causing an increase in the pressure of the permeate at the permeate side of the at least one reverse osmosis membrane and reducing the feed pressure without significantly increasing the permeate pressure.

Preferably, the reducing the feed pressure includes reducing the feed pressure to a pressure which is less than the osmotic pressure of the saline water. Alternatively, the reducing the feed pressure includes reducing the feed pressure to a pressure required for reverse osmosis desalination of saline feed water, wherein the feed pressure exceeds the osmotic pressure of the saline feed water.

In accordance with a preferred embodiment of the present invention the feed pressure is generally constant other than during the intermittent cleaning of the at least one reverse osmosis membrane.

Preferably, the feed pressure varies at times other than only during the intermittent cleaning of the at least one reverse osmosis membrane.

In accordance with a preferred embodiment of the present invention the feed pressure varies as a function of salinity of the saline water at the feed side of the at least one reverse osmosis membrane.

Preferably, the feed pressure varies proportionally to a rate of flow through the at least one reverse osmosis desalination unit up to a predetermined threshold.

In accordance with a preferred embodiment of the present invention the sum of the permeate pressure and the osmotic pressure of the saline water is generally at least equal to the feed pressure.

Preferably, the intermittent cleaning control subsystem is operative to increase the pressure of the permeate at the permeate side by at least one of narrowing the permeate outlet and closing the permeate outlet while reducing the feed pressure.

There is also provided in accordance with another preferred embodiment of the present invention a method for desalination of water including supplying at least one reverse osmosis desalination unit including at least one reverse osmosis membrane and having a saline water inlet at a feed side of the at least one reverse osmosis membrane and a permeate outlet at a permeate side of the at least one reverse osmosis membrane, feeding saline water containing foulants to the at least one reverse osmosis desalination unit via the saline water inlet at a feed pressure which exceeds the osmotic pressure of the saline water, thereby causing permeate to flow through the at least one reverse osmosis membrane to the permeate side of the at least one reverse osmosis membrane and foulants to be trapped in the at least one reverse osmosis membrane and intermittently cleaning the at least one reverse osmosis membrane by causing the permeate to pass through the reverse osmosis membrane from the permeate side to the feed side, thereby dislodging foulants from the reverse osmosis membrane into the saline water at the feed side of the at least one reverse osmosis membrane, enabling the foulants to be flushed from the feed side to a location outside of the at least one reverse osmosis desalination unit by at least one of narrowing the permeate outlet, thereby causing an increase of pressure of the permeate at the permeate side of the at least one reverse osmosis membrane to rise, closing the permeate outlet, thereby causing an increase of pressure of the permeate at the permeate side of the at least one reverse osmosis membrane to rise and reducing the feed pressure without significantly increasing the permeate pressure.

Preferably, the reducing the feed pressure includes reducing the feed pressure to a pressure which is less than the osmotic pressure of the saline water.

In accordance with a preferred embodiment of the present invention the reducing the feed pressure includes reducing the feed pressure to a pressure required for reverse osmosis desalination of saline feed water, wherein the feed pressure exceeds the osmotic pressure of the saline feed water.

Preferably, the feed pressure is generally constant other than during the intermittent cleaning of the at least one reverse osmosis membrane.

In accordance with a preferred embodiment of the present invention the feed pressure varies at times other than only during the intermittent cleaning of the at least one reverse osmosis membrane. Additionally, the feed pressure varies as a function of salinity of the saline water at the feed side of the at least one reverse osmosis membrane. Alternatively, the feed pressure varies proportionally to a rate of flow through the at least one reverse osmosis desalination unit up to a predetermined threshold.

In accordance with a preferred embodiment of the present invention the sum of the permeate pressure and the osmotic pressure of the saline water is generally at least equal to the feed pressure.

Preferably, the intermittently cleaning includes at least one of narrowing and closing the permeate outlet and reducing the feed pressure.

### BRIEF DESCRIPTION OF THE DRAWINGS

The present invention will be understood and appreciated more fully from the following detailed description, taken in conjunction with the drawings in which:

FIG. 1A is a simplified illustration of a desalination system constructed and operative in accordance with a preferred embodiment of the present invention;

FIG. 1B illustrates operation of the system of FIG. 1A wherein intermittent cleaning is achieved by narrowing or closing the permeate outlet;

FIG. 1C illustrates operation of the system of FIG. 1A wherein intermittent cleaning is achieved by reducing the saline water pressure to a pressure which is less than the osmotic pressure of the saline water, without significantly increasing the permeate pressure;

FIG. 1D illustrates operation of the system of FIG. 1A wherein intermittent cleaning is achieved by significantly increasing the permeate pressure by narrowing or closing the permeate outlet and reducing the saline water pressure to a pressure which is less than the osmotic pressure of the saline water;

FIG. 2A is a simplified illustration of a desalination system constructed and operative in accordance with another preferred embodiment of the present invention;

FIG. 2B illustrates operation of the system of FIG. 2A wherein intermittent cleaning is achieved by narrowing or closing the permeate outlet and reducing the saline water pressure;

FIG. 2C illustrates operation of the system of FIG. 2A wherein intermittent cleaning is achieved by reducing the saline water pressure to a pressure which is less than the osmotic pressure of the saline water without significantly increasing the permeate pressure; and

FIG. 2D illustrates operation of the system of FIG. 2A wherein intermittent cleaning is achieved by significantly increasing the permeate pressure by narrowing or closing the permeate outlet and reducing the saline water pressure to a pressure which is less than the osmotic pressure of the saline water.

### DETAILED DESCRIPTION OF PREFERRED EMBODIMENTS

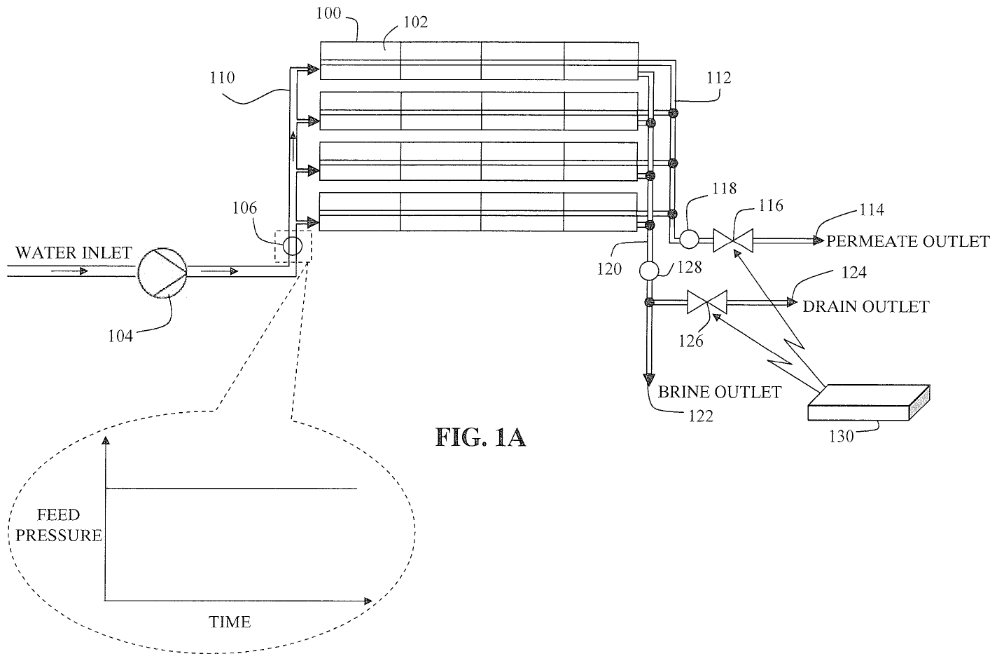

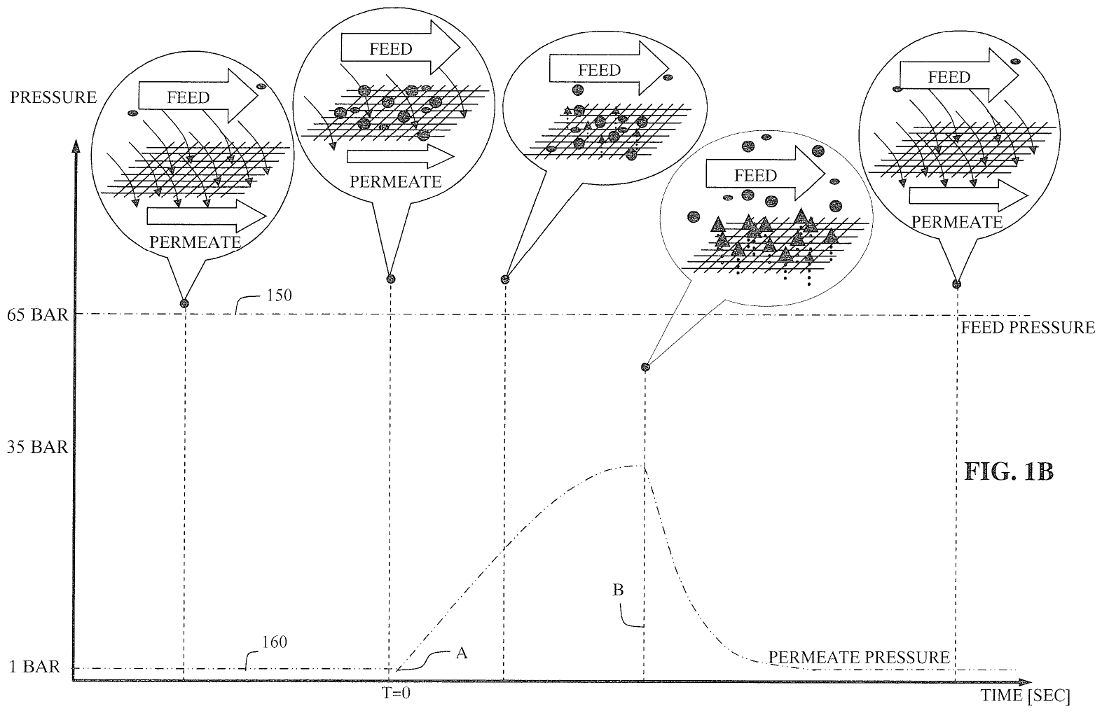

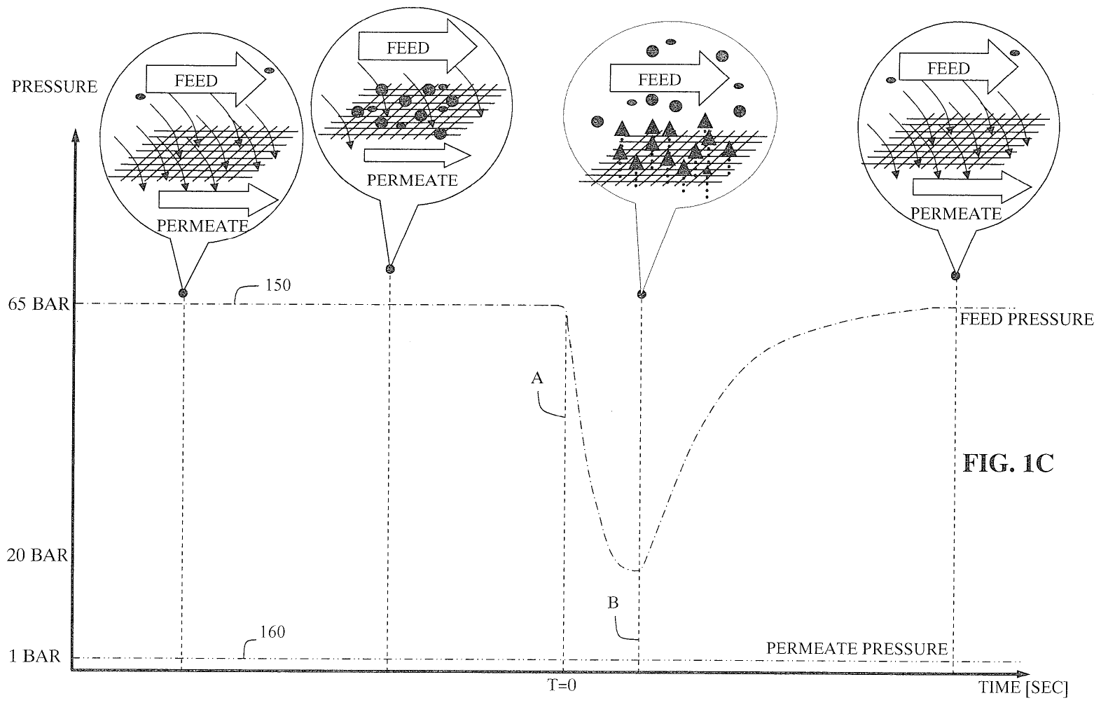

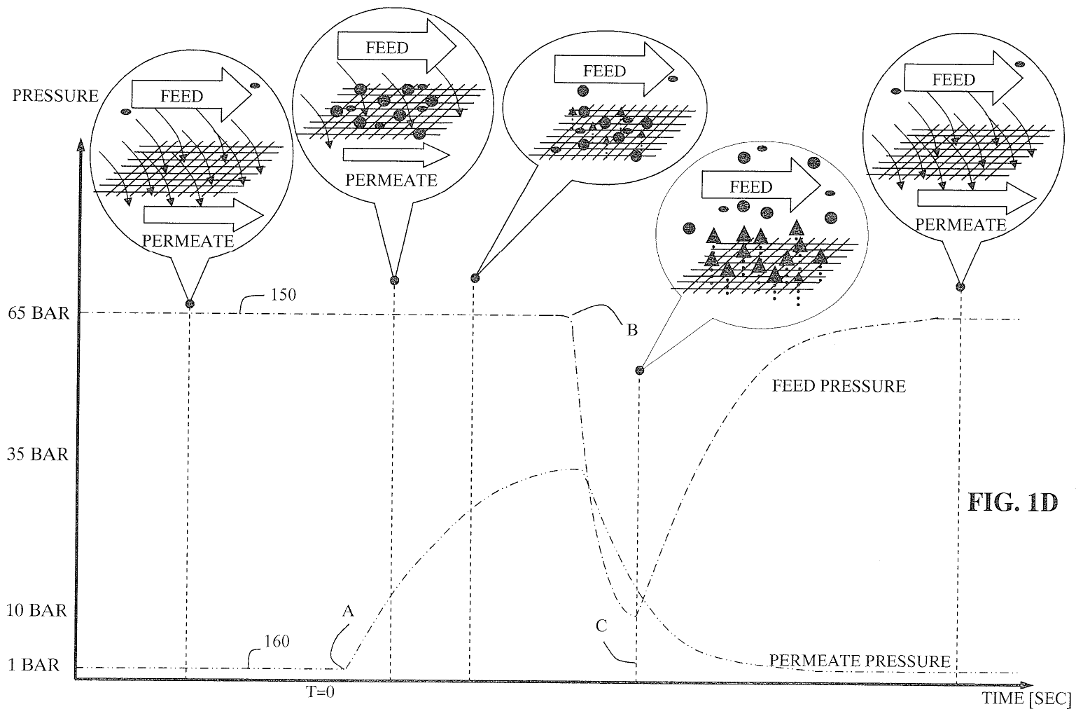

Reference is now made to FIG. 1A, which is a simplified illustration of a desalination system constructed and operative in accordance with a preferred embodiment of the present invention, and to FIGS. 1B, 1C and 1D which are simplified time-line illustrations of cleaning operations of the system of FIG. 1A.

The desalination system of FIG. 1A comprises at least one reverse osmosis desalination unit and is operative for reverse osmosis desalination of feed water, whose pressure is generally uniform over time, and intermittent cleaning of at least one reverse osmosis membrane by causing permeate to pass through the at least one reverse osmosis membrane from a permeate side to a feed side, thereby dislodging foulants from the at least one reverse osmosis membrane into saline water at the feed side of the at least one reverse osmosis membrane, enabling the foulants to be flushed from the feed side to a location outside of the at least one reverse osmosis desalination unit.

In the present description, the term “foulants” is used to describe both bio foulants and scale.

It is a particular feature of the present invention that the intermittent cleaning is achieved by at least one of:

narrowing or closing the permeate outlet, thereby causing an increase of pressure of the permeate at the permeate side of the reverse osmosis membrane; and

reducing the feed pressure to a pressure which is less than the osmotic pressure of the saline water, without significantly increasing the permeate pressure. Preferably, when reducing the feed pressure to a pressure which is less than the osmotic pressure of the saline water without significantly increasing the permeate pressure, the permeate pressure is not increased at all.

FIG. 1B illustrates operation of the system of FIG. 1A wherein intermittent cleaning is achieved by narrowing or closing the permeate outlet.

FIG. 1C illustrates operation of the system of FIG. 1A wherein intermittent cleaning is achieved by reducing the feed pressure to a pressure which is less than the osmotic pressure of the saline water without significantly increasing the permeate pressure. As shown in FIG. 1C, in the illustrated embodiment, the permeate pressure is not increased.

FIG. 1D illustrates operation of the system of FIG. 1A wherein intermittent cleaning is achieved by significantly increasing the permeate pressure by narrowing or closing the permeate outlet and reducing the feed pressure to a pressure which is less than the osmotic pressure of the saline water.

Turning initially to FIG. 1A, there is seen a simplified desalination system comprising at least one reverse osmosis desalination unit including a plurality of reverse osmosis pressure vessels 100 arranged in parallel. Each pressure vessel 100 preferably includes a plurality of reverse osmosis membrane elements 102, typically eight in number, only four being shown in the drawing for the sake of conciseness. Reverse osmosis pressure vessels 100 are commercially available from multiple vendors, such as BEL Composite Industries Ltd, Industrial Zone, Kiryat Yehudit, P.O.B. 4, 84100 Beer Sheva, Israel and reverse osmosis membrane elements 102 are commercially available from multiple vendors, such as Hydranautics, 401 Jones Road, Oceanside, Calif. 92058.

Water to be treated is supplied at a water inlet and is pressurized by a pump 104, preferably operative to pressurize the water to be treated to typical pressures of approximately 15 bar for brackish water and up to approximately 65 bar for sea water. Pump 104 may be any suitable type of pump, such as a positive displacement pump. An example of a preferred positive displacement pump is a Danfoss APP 21-38 high pressure pump, commercially available from Danfoss A/S Nordborgvej 81, 6430 Nordborg, Denmark. Preferably, a pressure sensor 106 is provided downstream of pump 104. A typical graph of pressure as measured by pressure sensor 106 vs. time appears in an enlargement forming part of FIG. 1A.

The water to be treated, hereinafter referred to as saline water, wherein the definition of “saline water” also encompasses, inter alia, “saline solution” and “feed water”, is supplied via a manifold 110 to the parallel pressure vessels 100. Desalinated permeate, hereinafter referred to as permeate, wherein the definition of “permeate” also encompasses, inter alia, “product water”, from each of pressure vessels 100, is preferably supplied via a permeate manifold 112 to a permeate outlet 114 via a permeate outlet control valve 116. A permeate pressure sensor 118 is preferably located upstream of permeate outlet control valve 116. Concentrate from each of pressure vessels 100 is preferably supplied via a manifold 120 to a brine outlet 122. An output of manifold 120 is also coupled to a drain outlet 124 via a drain outlet control valve 126. A pressure sensor 128 is provided downstream of manifold 120 and upstream of brine outlet 122 and drain outlet 124.

In accordance with a preferred embodiment of the present invention, there is provided a Closing Permeate Outlet Reducing Feed Pressure (CPORFP) Controller 130, which controls the operation of permeate outlet control valve 116 and also controls the operation of drain outlet control valve 126, for intermittently cleaning foulants from the reverse osmosis membrane elements 102.

Further in accordance with a preferred embodiment of the invention, intermittent cleaning of the reverse osmosis membrane elements 102 is achieved by:

narrowing or closing the permeate outlet 114 by at least partially closing permeate outlet control valve 116, thereby causing the pressure of the permeate, as measured by pressure sensor 118, at the permeate side of the reverse osmosis membrane element 102, to increase and approach the differential pressure across the membrane element, which is closest to the inlet of the pressure vessel 100. This differential pressure is typically in the range of up to 35 bar in seawater desalination and possibly significantly lower in brackish water desalination; and

when the pressure, as measured by pressure sensor 118, of the permeate at the permeate side of the reverse osmosis membrane elements 102 increases and approaches the differential pressure across the membrane element, which is closest to the inlet of the pressure vessel 100, by opening drain outlet control valve 126, thus reducing the feed pressure, as measured by pressure sensor 128, to a pressure which is less than the osmotic pressure of saline water, thereby causing the permeate to pass through the reverse osmosis membrane elements 102 from the permeate side to the feed side thereof, thereby dislodging foulants from the reverse osmosis membrane elements 102 into the saline water at the feed side of the reverse osmosis membrane elements 102, thus enabling the foulants to be flushed from the feed side to the brine outlet 122 and out through the drain outlet 124.

A preferred methodology for intermittent cleaning of the reverse osmosis membrane elements 102 is now described with reference to FIGS. 1B, 1C and 1D. The cleaning process is preferably initiated when foulants accumulate inside a membrane element 102, which can be sensed in various ways. For example, a pressure drop across the reverse osmosis membrane elements 102 may be measured by pressure sensors 106 and 128 or by the use of other sensors which sense the presence of the foulants. When pressure sensors are employed, as described above, intermittent cleaning of the reverse osmosis membrane elements 102 is initiated when the pressure drop exceeds a predetermined threshold.

FIGS. 1B, 1C and 1D illustrate examples wherein seawater or brackish water is being desalinated.

It is appreciated that the pressure values given for the embodiments described in the context of FIGS. 1B-1D are values associated with membrane cleaning in a sea water desalination operation. While the embodiment shown specifically in FIG. 1B may be used in a sea water desalination operation, it is preferably used for membrane cleaning in a brackish water desalination operation.

Prior to initiation of the cleaning process, permeate outlet control valve 116 is open and drain outlet control valve 126 is closed. Feed water is supplied to the reverse osmosis membrane elements 102 and permeate is produced by conventional reverse osmosis techniques. The permeate flows out of the reverse osmosis membrane elements 102 via permeate outlet control valve 116. Foulants accumulate on the feed side of the reverse osmosis membrane elements. The feed pressure, as measured by pressure sensor 106, typically 65 bar, is indicated by trace 150. The permeate pressure, as measured by pressure sensor 118, typically 1 bar, is indicated by trace 160.

FIG. 1B illustrates an example where upon initiation of the cleaning process, as indicated at A and designated in time as T=0 seconds, permeate outlet control valve 116 is at least partially closed by CPORFP controller 130, thereby limiting or preventing outflow of permeate from permeate manifold 112, thereby causing the permeate pressure, as measured by pressure sensor 118, to gradually increase and approach the differential pressure across the membrane element which is closest to the inlet of the pressure vessel 100.

For example, in sea water desalination, if the feed pressure is 65 bar and the osmotic pressure in the membrane element which is closest to the inlet of the pressure vessel 100 is 30 bar, then the permeate pressure can rise up to 35 bar, as shown at B. This increase in the permeate pressure causes the permeate to pass through the reverse osmosis membrane elements 102 from the permeate side to the feed side thereof, thereby dislodging foulants from the reverse osmosis membrane elements 102 into the saline water at the feed side of the reverse osmosis membrane elements 102, thereby enabling the foulants to be flushed from the feed side to the brine outlet 122.

Typically after stage B, the CPORFP controller 130 opens permeate outlet control valve 116, thereby producing a rapid reduction in the permeate pressure. From this point forward until initiation of a further cleaning cycle, the system proceeds to produce permeate by conventional reverse osmosis techniques.

FIG. 1C illustrates an example wherein upon initiation of the cleaning process, as indicated at A and designated in time as T=0 seconds, drain outlet control valve 126 is operated by CPORFP controller 130 to drain brine not only via brine outlet 122 but also via drain outlet 124, thereby reducing the feed pressure to a level which is below the osmotic pressure.

Thereafter, typically shortly after stage A, the sum of the permeate pressure as measured by pressure sensor 118 and the osmotic pressure of the concentrate, which is a function of its salinity, exceeds the feed pressure, as measured by pressure sensor 106. As this pressure difference increases, a backwards flow of permeate through the reverse osmosis membrane elements 102 takes place, as indicated at B, thereby flushing foulants from the reverse osmosis membrane elements 102 back into the concentrate and allowing them to be flushed out through both the brine outlet 122 and the drain outlet 124.

Typically shortly after stage B, the CPORFP controller 130 closes drain outlet control valve 126, thereby restoring the initial feed pressure. From this point forward until initiation of a further cleaning cycle, the system proceeds to produce permeate by conventional reverse osmosis techniques.

FIG. 1D illustrates an example wherein upon initiation of the cleaning process, as indicated at A and designated in time as T=0 seconds, permeate outlet control valve 116 is at least partially closed by CPORFP controller 130, thereby limiting or preventing outflow of permeate from permeate manifold 112 and causing the permeate pressure, as measured by pressure sensor 118, to gradually increase and approach the differential pressure across the membrane element which is closest to the inlet of the pressure vessel 100.

Typically a few seconds after T=0, as indicated at B, drain outlet control valve 126, is opened by CPORFP controller 130 to drain brine to drain outlet 124, thereby reducing the feed pressure to a level which is below the osmotic pressure.

Thereafter, typically shortly after B, the sum of the permeate pressure as measured by pressure sensor 118 and the osmotic pressure of the concentrate, which is a function of its salinity, exceeds the feed pressure, as measured by pressure sensor 106. As this pressure difference increases, a backwards flow of permeate through the reverse osmosis membrane elements 102 takes place, as indicated at C, thereby flushing foulants from the reverse osmosis membrane elements 102 back into the concentrate and allowing them to be flushed through both the brine outlet 122 and the drain outlet 124.

Typically a few seconds after stage C, the CPORFP controller 130 opens permeate outlet control valve 116 and closes drain outlet control valve 126, thereby producing a rapid reduction in the permeate pressure and restoring the initial feed pressure. From this point forward until initiation of a further cleaning cycle, the system proceeds to produce permeate by conventional reverse osmosis techniques.

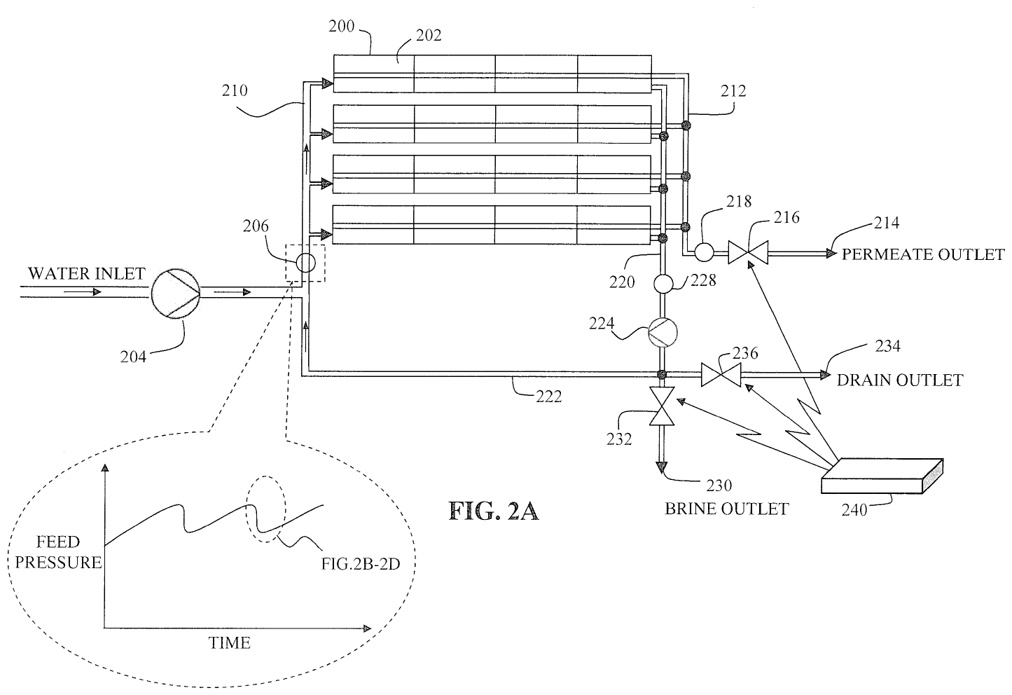

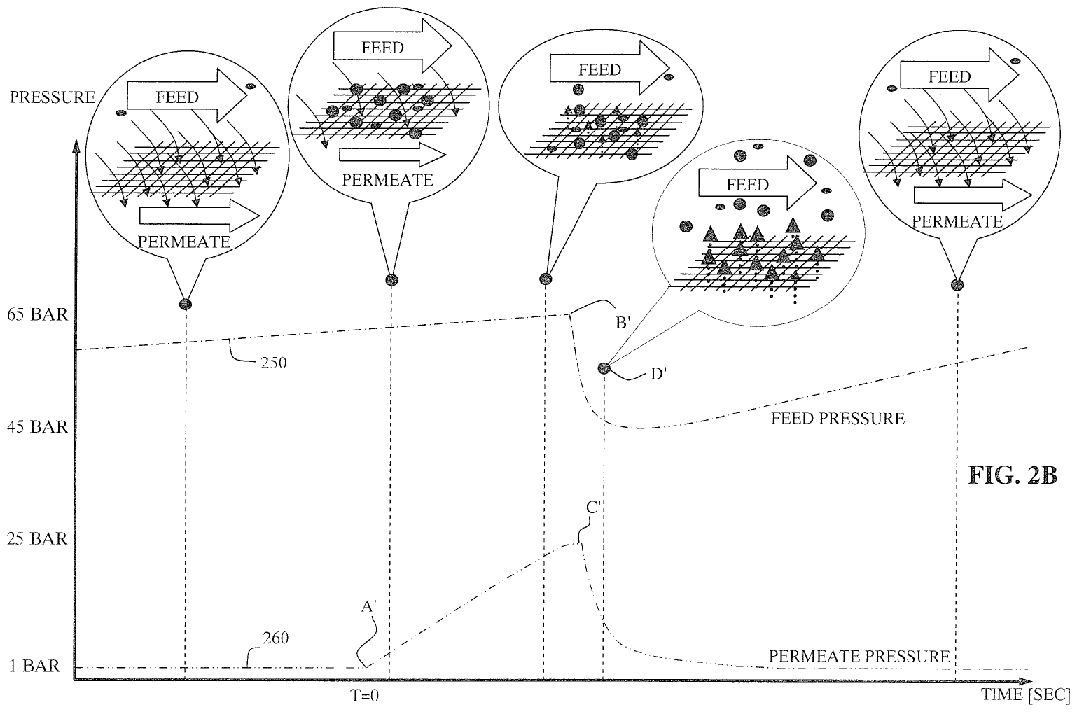

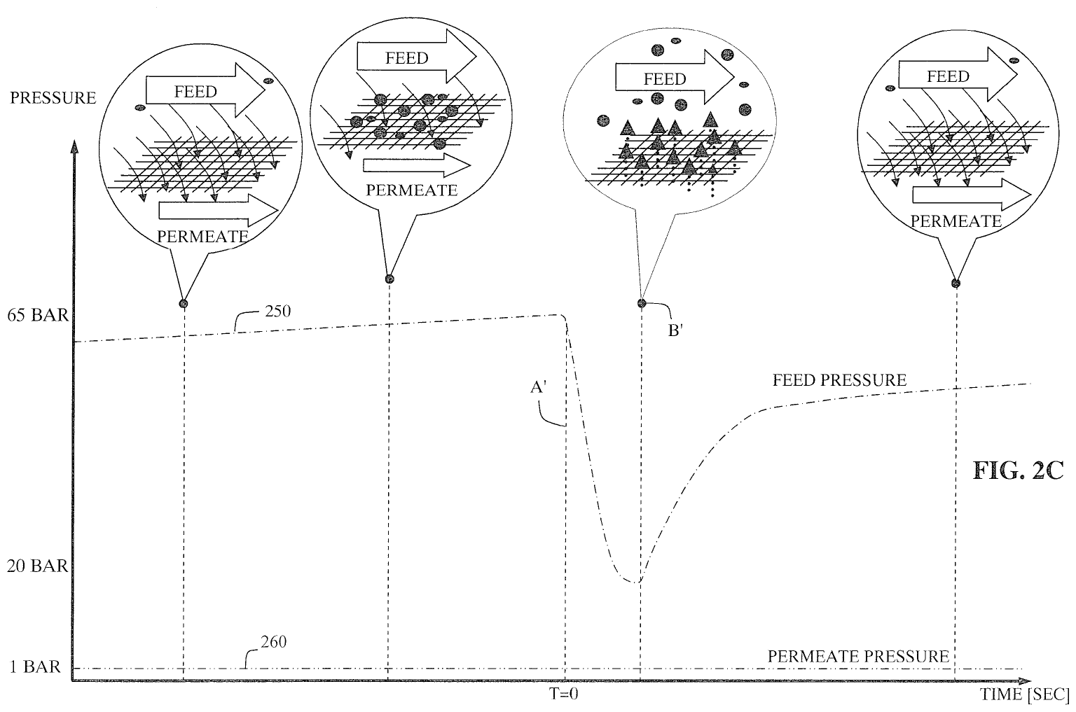

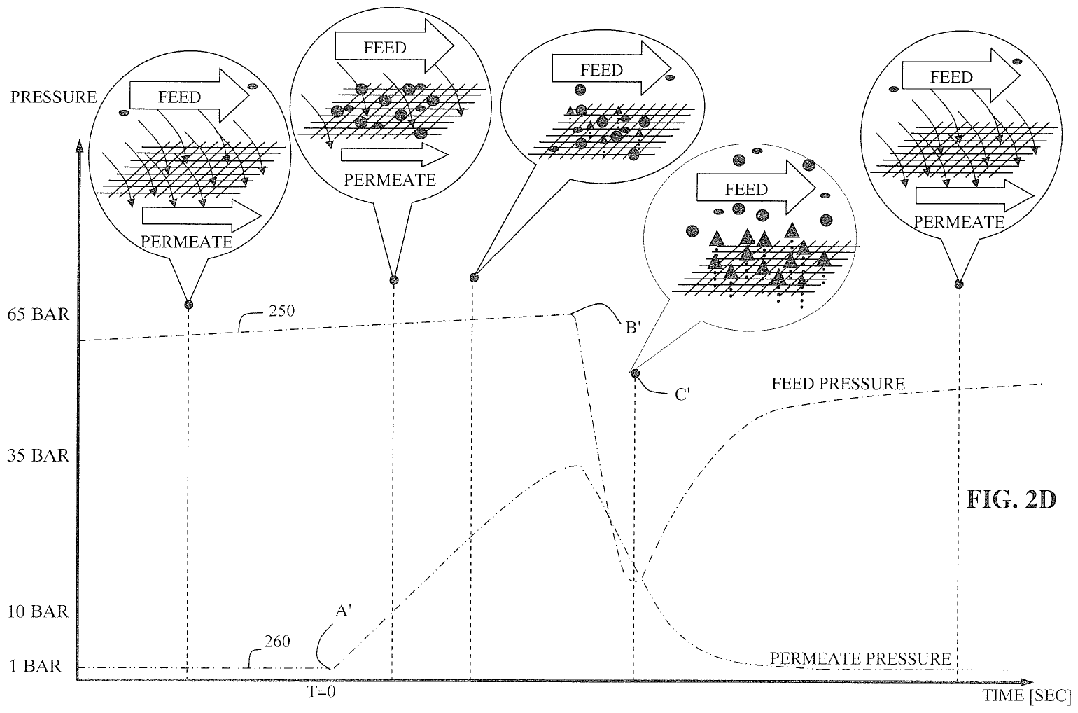

Reference is now made to FIG. 2A, which is a simplified illustration of a desalination system constructed and operative in accordance with a preferred embodiment of the present invention and to FIGS. 2B, 2C and 2D, which are simplified time-line illustrations of cleaning operations of the system of FIG. 2A.

The desalination system of FIG. 2A comprises at least one reverse osmosis desalination unit and is operative for reverse osmosis desalination of feed water, whose pressure varies over time as shown in an enlargement, forming part of FIG. 2A, and intermittent cleaning of at least one reverse osmosis membrane by causing permeate to pass through the at least one reverse osmosis membrane from a permeate side to a feed side, thereby dislodging foulants from the at least one reverse osmosis membrane into saline water at the feed side of the at least one reverse osmosis membrane, enabling the foulants to be flushed from the feed side to a location outside of the at least one reverse osmosis desalination unit.

Variations in the required feed pressure are a positive function of the salinity of the saline water entering the membrane elements and thus, if the salinity of the saline water entering the membrane elements increases, the feed pressure must be increased. Periodic variations in the salinity of the saline water entering the membrane elements, which result from periodic feedback of concentrate as will be described in detail hereinafter, thus result in periodic variation of the feed pressure.

The variation of feed pressure over time typically has a periodicity of a few minutes, typically between 3-30 minutes in seawater desalination and possibly longer in brackish water desalination. It is a particular feature of the embodiment of FIGS. 2A-2D that the variation of feed pressure is preferably utilized to provide enhanced energy efficiency in the intermittent cleaning of the reverse osmosis membrane.

It is a particular feature of the present invention that the intermittent cleaning is achieved by at least one of:

at least partially closing the permeate outlet, thereby causing an increase of pressure of the permeate at the permeate side of the reverse osmosis membrane to rise; and

reducing the feed pressure to a pressure required for reverse osmosis desalination of saline water entering the membrane elements, wherein the feed pressure may exceed the osmotic pressure of the saline water entering the membrane elements, without significantly increasing the permeate pressure. Preferably, the permeate pressure is not increased at all.

FIG. 2B illustrates operation of the system of FIG. 2A wherein intermittent cleaning is achieved by at least one of narrowing and closing the permeate outlet and reducing the feed pressure according to the desalination method illustrated in FIG. 2A.

FIG. 2C illustrates operation of the system of FIG. 2A, wherein intermittent cleaning is achieved by reducing the feed pressure to a pressure which is less than the osmotic pressure of the saline water without significantly increasing the permeate pressure. As shown in FIG. 2C, in the illustrated embodiment, the permeate pressure is not increased.

FIG. 2D illustrates operation of the system of FIG. 2A wherein intermittent cleaning is achieved by significantly increasing the permeate pressure by at least one of narrowing and closing the permeate outlet and reducing the feed pressure to a pressure which is less than the osmotic pressure of the saline water.

Turning initially to FIG. 2A, there is seen a simplified desalination system comprising at least one reverse osmosis desalination unit including a plurality of reverse osmosis pressure vessels 200 arranged in parallel. Each pressure vessel 200 preferably includes a plurality of reverse osmosis membrane elements 202, typically eight in number, only four being shown in the drawing for the sake of conciseness. Reverse osmosis pressure vessels 200 are commercially available from multiple vendors, such as BEL Composite Industries Ltd, Industrial Zone, Kiryat Yehudit P.O.B. 4, 84100 Beer Sheva, Israel and reverse osmosis membrane elements 202 are commercially available from multiple vendors, such as Hydranautics, 401 Jones Road, Oceanside, Calif. 92058.

Water to be treated is supplied at a water inlet and is pressurized by a pump 204, preferably operative to pressurize the water to be treated to typical pressures of approximately 20 bar for brackish water and up to approximately 65 bar for sea water. Pump 204 may be any suitable type of pump, such as a positive displacement pump. An example of a preferred positive displacement pump is a Danfoss APP 21-38 high pressure pump, commercially available from Danfoss A/S Nordborgvej 81, 6430 Nordborg, Denmark. Preferably a pressure sensor 206 is provided downstream of pump 204. A typical graph of pressure as measured by pressure sensor 206 vs. time is indicated in an enlargement forming part of FIG. 2A.

The water to be treated, hereinafter referred to as saline water, wherein the definition of “saline water” also encompasses inter alia “saline solution”, is supplied via a manifold 210 to the parallel pressure vessels 200. Desalinated permeate hereinafter referred to as permeate, wherein the definition of “permeate” also encompasses inter alia “product water”, from each of pressure vessels 200 is preferably supplied via a permeate manifold 212 to a permeate outlet 214 via a permeate outlet control valve 216.

A permeate pressure sensor 218 is preferably located upstream of permeate outlet control valve 216. Concentrate from each of pressure vessels 200 is preferably supplied via a manifold 220 to a recycle conduit 222, which directs concentrate back to an input to manifold 210 downstream of pump 204, by employing a circulation pump 224. A pressure sensor 228 is preferably provided downstream of manifold 220. Concentrate from each of pressure vessels 200 may also be supplied from manifold 220 to a brine outlet 230 via a brine outlet control valve 232. An output of manifold 220 is also coupled to a drain outlet 234 via a drain outlet control valve 236.

In accordance with a preferred embodiment of the present invention there is provided a CPORFP (Closing Permeate Outlet Reducing Feed Pressure) Controller 240, which controls the operation of permeate outlet control valve 216, brine outlet control valve 232 and drain outlet control valve 236 for intermittently cleaning foulants from the reverse osmosis membrane elements 202.

The periodic variations in the required feed pressure during desalination correspond to the periodic variations in the salinity of the saline water entering the membrane elements. The control over the variation of the feed pressure can be achieved in various ways, such as according to the flow rate or the salinity level of water being supplied to the reverse osmosis membrane elements 202. Alternatively, the feed pressure may be varied in accordance with a predetermined time schedule. Other alternative algorithms for control over the variation of the feed pressure may be employed.

Controller 240 is operative to periodically open and close brine outlet control valve 232 in accordance with a predetermined time schedule or alternatively, for example, in response to either sensed salinity of the concentrate or exceedance of a predetermined maximum feed pressure threshold. Other alternative algorithms for control of opening and closing brine outlet control valve 232 may be employed.

Once the concentration of the concentrate increases to a predetermined level at which continued desalination is deemed not to be practicable, the controller 240 opens brine outlet control valve 232 and the brine exits the system via brine outlet control valve 232 to brine outlet 230. New feed water enters the system, with significantly lower salinity. When brine outlet control valve 232 is closed, the concentrate is directed back to the input of the manifold 210 via the recycle conduit 222. In the manifold 210, the concentrate blends with fresh feed water and enters membrane elements 202 for further desalination.

Typically the predetermined level of concentrate concentration is based on one of a number of operational considerations, such as rate of accumulation of foulants and energy efficiency.

As a result of the entry of new feed water, the feed pressure, as measured by pressure sensor 206, is accordingly reduced. The feed pressure is thereafter gradually increased as the salinity of the water being supplied to the reverse osmosis membrane elements 202 increases and the above-described recycling process is repeated.

In accordance with a preferred embodiment of the invention, intermittent cleaning of the reverse osmosis membrane elements 202 is achieved by:

limiting or closing the permeate outlet 214 (CPO) by at least partially closing permeate outlet control valve 216, thereby causing the pressure of the permeate, as measured by pressure sensor 218, at the permeate side of the reverse osmosis membrane element 202, to increase and approach the differential pressure across the membrane element which is closest to the inlet of the pressure vessel 200. This differential pressure is typically in the range of up to 25 bar in seawater desalination and possibly significantly lower in brackish water desalination; and

when the pressure, as measured by pressure sensor 218, of the permeate at the permeate side of the reverse osmosis membrane elements 202 increases and approaches the differential pressure across the membrane element which is closest to the inlet of the pressure vessel 200, by opening the brine outlet control valve 232 and/or the drain outlet control valve 236, thus reducing the feed pressure, as measured by pressure sensor 206, to a pressure which is less than the osmotic pressure of saline water, thereby causing the permeate to pass through the reverse osmosis membrane elements 202 from the permeate side to the feed side thereof, thus dislodging foulants from the reverse osmosis membrane elements 202 into the saline water at the feed side of the reverse osmosis membrane elements 202, thereby enabling the foulants to be flushed from the feed side to the brine outlet 230 and out through the drain outlet 234. The opening of the brine outlet control valve 232 is in accordance with a preferred embodiment of the invention as in FIG. 2A.

A preferred methodology for intermittent cleaning of the reverse osmosis membrane elements 202 is now described with reference to FIGS. 2B, 2C and 2D. The cleaning process is preferably initiated when foulants accumulate inside a membrane element 202, which can be sensed in various ways. For example, a pressure drop across the reverse osmosis membrane elements 202 may be measured by pressure sensors 206 and 228 or by the use of other sensors which sense the presence of the foulants. When pressure sensors are employed, as described above, intermittent cleaning of the reverse osmosis membrane elements 202 is initiated when the pressure drop exceeds a predetermined threshold.

FIGS. 2B, 2C and 2D illustrate examples wherein seawater is being desalinated. Prior to initiation of the cleaning process, permeate outlet control valve 216 is open and brine outlet control valve 232 and drain outlet control valve 236 are closed. Feed water is supplied to the reverse osmosis membrane elements 202 and permeate is produced by reverse osmosis techniques. The permeate flows out of the reverse osmosis membrane elements 202 via permeate outlet control valve 216. Foulants accumulate on the feed side of the reverse osmosis membrane elements 202. The feed pressure, as measured by pressure sensor 206, typically increases up to 65 bar, is indicated by trace 250. The permeate pressure, as measured by pressure sensor 218, typically 1 bar, is indicated by trace 260.

FIG. 2B illustrates an example where upon initiation of the cleaning process, as indicated at A′ and designated in time as T=0 seconds, permeate outlet control valve 216 is at least partially closed by CPORFP controller 240, thereby limiting or preventing outflow of permeate from permeate manifold 212 and causing the permeate pressure, as measured by pressure sensor 218, to gradually increase and approach the differential pressure across the membrane element which is closest to the inlet of the pressure vessel 200.

For example, in sea water desalination, if the feed pressure is 65 bar and the osmotic pressure in the membrane element which is closest to the inlet of the pressure vessel 200 is 40 bar, then the permeate pressure can rise up to 25 bar, as shown in FIG. 2B at C′. This increase in the permeate pressure causes the permeate to pass through the reverse osmosis membrane elements 202 from the permeate side to the feed side thereof, thereby dislodging foulants from the reverse osmosis membrane elements 202 into the saline water at the feed side of the reverse osmosis membrane elements 202, thus enabling the foulants to be flushed from the feed side to the brine outlet 230. At a permeate pressure of 25 bar, there is no production of permeate in any of membrane elements 202.

Typically a few seconds after T=0, as indicated at B′, brine outlet control valve 232 is operated by CPORFP controller 240 to drain brine to brine outlet 230 and replace it with new feed water, with significantly lower salinity, and the feed pressure is thus reduced, as mentioned above.

Thereafter, typically shortly after B′, the sum of the permeate pressure, as measured by pressure sensor 218, and the osmotic pressure of the brine, which is a function of its salinity, exceeds the reduced feed pressure, as measured by pressure sensor 206. As this pressure difference increases, a backwards flow of permeate through the reverse osmosis membrane element 202 takes place, as indicated at D′ thereby flushing foulants from the reverse osmosis membrane elements 202 back into the concentrate and allowing them to be flushed to the brine outlet 230.

Typically a shortly after D′, the CPORFP controller 240 opens permeate outlet control valve 216 and closes brine outlet control valve 232, thereby producing a rapid reduction in the permeate pressure. From this point forward until initiation of a further cleaning cycle, the system proceeds to produce permeate by the reverse osmosis technique described hereinabove with reference to FIG. 2A.

FIG. 2C illustrates an example wherein upon initiation of the cleaning process, as indicated at A′ and designated in time as T=0 seconds, brine outlet control valve 232 and drain outlet control valve 236 are operated by CPORFP controller 240 to drain brine to drain outlet 234 and to brine outlet 230, thereby reducing the feed pressure to a level which is below the osmotic pressure.

Thereafter, typically shortly after A′, the sum of the permeate pressure, as measured by pressure sensor 218, and the osmotic pressure of the concentrate, which is a function of its salinity, exceeds the feed pressure, as measured by pressure sensor 206. As this pressure difference increases, a backwards flow of permeate through the reverse osmosis membrane elements 202 takes place, as indicated at B′, thereby flushing foulants from the reverse osmosis membrane elements 202 back into the concentrate and allowing them to be flushed to the brine outlet 230 and to the drain outlet 234.

Typically shortly after B′, the CPORFP controller 240 closes brine outlet control valve 232 and drain outlet control valve 236, thereby restoring the initial feed pressure. From this point forward until initiation of a further cleaning cycle, the system proceeds to produce permeate by the reverse osmosis technique described hereinabove with reference to FIG. 2A.

FIG. 2D illustrates an example wherein, upon initiation of the cleaning process, as indicated at A′ and designated in time as T=0 seconds, permeate outlet control valve 216 is at least partially closed by CPORFP controller 240, thereby limiting or preventing outflow of permeate from permeate manifold 212 and causing the permeate pressure, as measured by pressure sensor 218, to gradually increase and approach the differential pressure across the membrane element which is closest to the inlet of the pressure vessel 200.

Typically a few seconds after T=0, as indicated at B′, brine outlet control valve 232 and drain outlet control valve 236 are opened by CPORFP controller 240 to drain brine to drain outlet 234 and to brine outlet 230, thereby reducing the feed pressure to a level which is below the osmotic pressure.

Thereafter, typically shortly after B′, the sum of the permeate pressure, as measured by pressure sensor 218, and the osmotic pressure of the concentrate, which is a function of its salinity, exceeds the feed pressure, as measured by pressure sensor 206. As this pressure difference increases, a backwards flow of permeate through the reverse osmosis membrane elements 202 takes place, as indicated at C′ thereby flushing foulants from the reverse osmosis membrane elements 202 back into the concentrate and allowing them to be flushed to brine outlet 230 and to drain outlet 234.

Typically shortly after C′, the CPORFP controller 240 opens permeate outlet control 216 and closes brine outlet control valve 232 and drain outlet control valve 236, thereby producing a rapid reduction in the permeate pressure and restoring the initial feed pressure. From this point forward until initiation of a further cleaning cycle, the system proceeds to produce permeate by the reverse osmosis technique described hereinabove with reference to FIG. 2A.

It will be appreciated by persons skilled in the art that the present invention is not limited to what has been particularly shown and described hereinabove. Rather the scope of the present invention includes both combinations and sub-combinations of various features described hereinabove as well as variations and modifications thereof which would occur to a person skilled in the art upon reading the foregoing and which are not in the prior art.

1. A method for water treatment, the method comprising:
providing a water treatment system comprising:
at least one water treatment unit including at least one membrane having a feed water inlet at a feed side thereof, a permeate outlet at a permeate side thereof, and a concentrate outlet;
a recirculation conduit arranged between said concentrate outlet and said feed water inlet;
a circulation pump arranged in communication with said recirculation conduit;
a brine outlet in communication with said recirculation conduit; and
a brine outlet control valve arranged between said brine outlet and said recirculation conduit, and configured to open and close said brine outlet;
operating the water treatment system in a normal operation mode, wherein operating the water treatment system in the normal operation mode comprises:
feeding feed water containing foulants through a pump to said at least one water treatment unit via said feed water inlet at a feed pressure which exceeds the osmotic pressure of said feed water, thereby causing permeate to flow through said at least one membrane to said permeate side of said at least one membrane under a positive net driving differential pressure and foulants to be trapped in said at least one membrane; and
circulating concentrate from said concentrate outlet to said feed water inlet via said recirculation conduit and said circulation pump, and mixing said concentrate with said feed water downstream said pump and upstream said feed water inlet;
wherein while operating the water treatment system in the normal operation mode, said brine outlet control valve is in a closed position;
upon detecting that a predetermined level of concentration of said concentrate is reached, switching from the normal operation mode to a cleaning mode; and
operating the water treatment system in the cleaning mode, wherein operating the water treatment system in the cleaning mode comprises:
initiating reduction of said feed pressure while continuing said circulating the concentrate, said mixing the concentrate with the feed water upstream said feed water inlet, and said feeding the feed water containing foulants to said at least one water treatment unit via said feed water inlet, intermittently yielding a negative net driving differential pressure to cause said permeate to pass through said at least one membrane from said permeate side to said feed side, thereby dislodging foulants from said at least one membrane into said feed water at said feed side of said at least one membrane, enabling said foulants to be flushed from said feed side to a location outside of said at least one water treatment unit, thereby cleaning said at least one membrane;
wherein said step of yielding a negative net driving differential pressure is performed by at least one of:
narrowing and/or closing said permeate outlet, thereby causing an increase in the pressure of said permeate at said permeate side of said at least one membrane; or
further reducing said feed pressure.

2. The method for water treatment according to claim 1, wherein initiating said reduction of said feed pressure comprises reducing said feed pressure to a pressure which is less than the osmotic pressure of said feed water.

3. The method for water treatment according to claim 1, wherein said feed pressure varies during said water treatment.

4. The method for water treatment according to claim 1, wherein said feed pressure varies during said step of circulating as a function of salinity of said feed water at said feed side of said at least one membrane.

5. The method for water treatment according to claim 1, wherein said net driving differential pressure is constituted substantially by said feed pressure, from which said permeate pressure and said osmotic pressure are subtracted.

6. The method for water treatment according to claim 1, wherein further reducing said feed pressure is performed by opening a drain outlet that is in communication with said recirculation conduit.

7. The method for water treatment according to claim 1, wherein said initiation of reduction of the feed pressure is performed by opening the brine outlet control valve.
